(19) United States
(12) Patent Application Publication
(10) Pub. No.: US 2015/0074569 A1
(43) Pub. Date: Mar. 12, 2015

(54) Display Device, Display Method and Display System

(71) Applicant: Kabushiki Kaisha Toshiba, Tokyo (JP)

(72) Inventor: Noriyuki Hirayama, Fuchu-shi (JP)

(21) Appl. No.: 14/455,547

(22) Filed: Aug. 8, 2014

Related U.S. Application Data
(60) Provisional application No. 61/877,145, filed on Sep. 12, 2013.

(51) Int. Cl. G06F 3/0481; G05D 23/19; G06F 3/0484

(52) U.S. Cl. CPC G06F 3/04817; G06F 3/04842; G05D 23/1917
USPC 715/765

(57) ABSTRACT

A display device includes a CPU (central processing unit), a display controller and an obtain module. The display controller displays a first icon and a second icon in predetermined layouts on a display. The first icon receives an instruction for executing a mode in relation to cooling and the second icon receives an instruction for executing a mode in relation to heating. The obtain module obtains information on at least one of air temperature and date. The display controller changes a layout of one icon of the first and second icons and maintains a layout of the other icon of the first and second icons based on the information when the information meets a predetermined condition.

### CROSS-REFERENCE TO RELATED APPLICATIONS

This application claims the benefit of U.S. Provisional Application No. 61/877,145, filed Sep. 13, 2013, the entire contents of which are incorporated herein by reference.

### FIELD

An embodiment of the present invention relates to a display device, a display method and a display system.

### BACKGROUND

Conventionally, in order to control home electrical appliances and apparatuses, a remote controller for provide the control for each home electrical appliance and apparatus has been previously offered. This type of remote controller has been generally designed for each home electrical appliance and apparatus in accordance with the specification of equipment concerned.

Information communication tends to be developed in recent years. Therefore, a technology has been offered in which a variety of services is provided to citizens by connecting home electrical appliances and apparatuses to facilitate the control. For example, with the development of information communication in recent years, a communication protocol such as ECHONET lite has been known in general for controlling in-home equipment.

### BRIEF DESCRIPTION OF THE DRAWINGS

FIG. 1 is a diagram showing an example of a household equipment communication system according to an embodiment.

FIG. 2 is a block diagram showing an example of a hardware configuration of a display device according to an embodiment.

FIG. 3 is a block diagram showing a structural example of a program executed in the display device according to an embodiment.

FIG. 4 is a diagram showing an example of a processing flow of a program executed in the display device according to an embodiment.

FIG. 5 is a diagram showing an example of a screen according to the embodiment.

FIG. 6 is a diagram showing an example of a screen according to the embodiment.

FIG. 7 is a diagram showing an example of a screen according to the embodiment.

FIG. 8 is a diagram showing an example of a screen according to the embodiment.

FIG. 9 is a diagram showing an example of a screen according to the embodiment.

### DETAILED DESCRIPTION

According to one embodiment, a display device includes a CPU (central processing unit), a display controller and an obtain module. The display controller displays a first icon and a second icon in predetermined layouts on a display. The first icon receives an instruction for executing a mode in relation to cooling and the second icon receives an instruction for executing a mode in relation to heating. The obtain module obtains information on at least one of air temperature and date. The display controller changes a layout of one icon of the first and second icons and maintains a layout of the other icon of the first and second icons based on the information when the information meets a predetermined condition.

Various Embodiments will be described hereinafter with reference to the accompanying drawings.

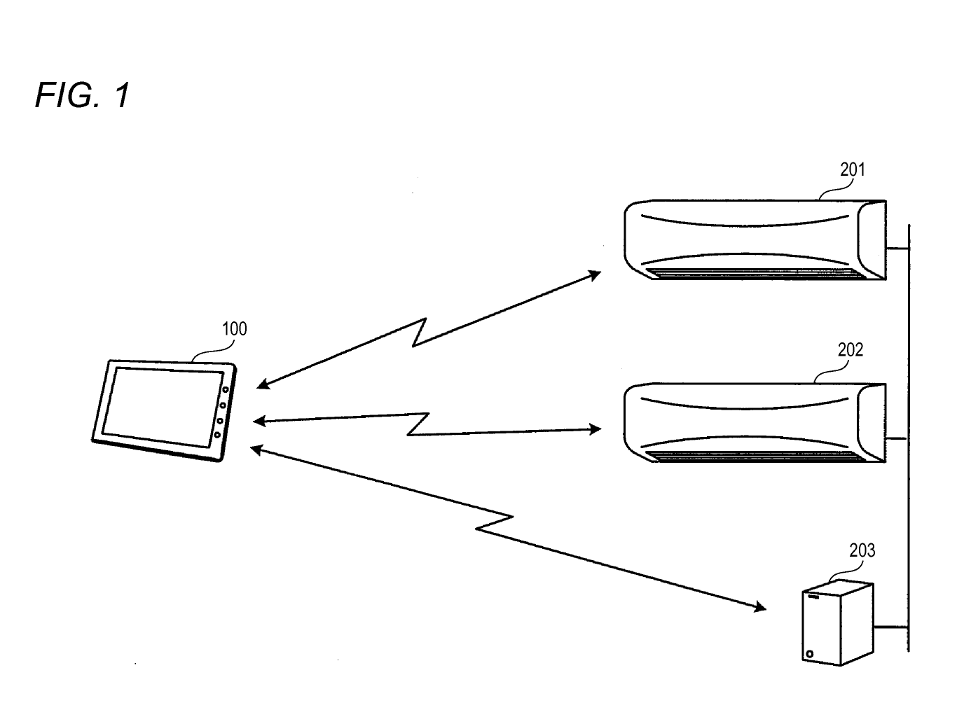

FIG. 1 is a diagram showing an example of a household equipment communication system according to an embodiment. The household equipment communication system is equipped with a first air conditioning device 201 and a second air conditioning device 202. The air conditioning devices may be installed in a single room, or may be installed in rooms different from each other. Furthermore, each of the air conditioning devices is connected to an outdoor unit (not shown). Then, these air conditioning devices have a function of measuring air temperature and humidity in a room, and the outdoor unit has a function of measuring air temperature outside the room to inform it to an indoor unit (the air conditioning device). Then, in the household equipment communication system according to the present embodiment, for example, a portable tablet-type display device controls these air conditioning devices using wired or wireless communication. In addition, the display device may not portable, but may be a stationary type, or may be a type of being embedded in a house, for example.

An operation application for operating the air conditioning devices is installed in a display device 100 according to the present embodiment. In addition, the explanation of authentication between the operation application and the apparatuses will be omitted because a conventionally-offered technique and the like can be used therefor. Then, a user can operate the first air conditioning device 201 and the second air conditioning device 202 by operating a touch panel of the display device 100.

In the embodiment shown in FIG. 1, Bluetooth connects the display device 100 to the first air conditioning device 201 and the second air conditioning device 202. Furthermore, in the present embodiment, ECHONET Lite communication protocol is used as a communication protocol at the layer higher than Bluetooth.

ECHONET Lite communication protocol is a protocol which has been offered for collectively managing in-home setting equipment and the like in an energy management system for domestic use called HEMS (Home Energy Management System). In addition, the present embodiment is not limited to ECHONET Lite, but may use other communication protocol.

Furthermore, in the present embodiment, there is also not a limitation on a communication protocol at a layer lower than ECHONET Lite, and thus IEEE802.11b/g/n, IEEE802.15.4, etc., may be used instead of Bluetooth, for example. In this case, the display device 100 wirelessly communicates with a wireless communication adapter 203. Then, the wireless communication adapter 203 communicates with the first air conditioning device 201 and the second air conditioning device 202 linked by wireless or wired connection (such as Ethernet). This makes the display device 100 possible to communicate with the first air conditioning device 201 and the second air conditioning device 202 through the wireless communication adapter 203.

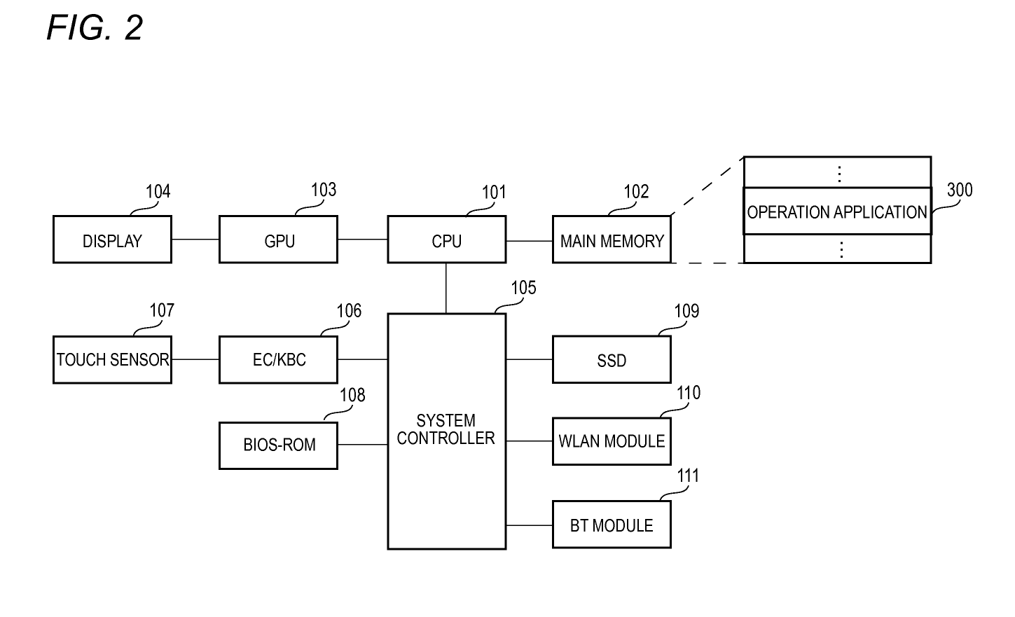

FIG. 2 is a block diagram showing an example of a hardware configuration of the display device 100. The display device 100 according to a first embodiment is provided with a CPU (Central Processing Unit) 101, a main memory 102, a GPU (Graphics Processing Unit) 103, a display 104, a system controller 105, an EC/KBC (Embedded Controller/Keyboard Controller) 106, a touch sensor 107, a BIOS-ROM 108, an SSD (Solid State Drive) 109, a WLAN (Wireless Local Area Network) module, a BT (Bluetooth) module 111, etc.

The CPU 101 is a processor for controlling the operation of each component of the display device 100. The CPU 101 executes a program, such as an operating system (OS), an operation application 300, etc., which is loaded from the SSD 109 to the main memory 102.

Furthermore, the CPU 101 also executes BIOS (Basic Input Output System) stored in the BIOS-ROM 108 which is a nonvolatile memory. BIOS is a system program for the hardware control.

The GPU 103 is a display controller for controlling the display 104 used as a display monitor of the display device 100. The GPU 103 generates a display signal to be supplied to the display 104 from the display data stored in a video memory (not shown).

The system controller 105 is a bridge device which provides a connection between the CPU 101 and each component. The system controller 105 contains a serial ATA controller for controlling the SSD 109.

The EC/KBC 106 is a single-chip microcomputer on which an embedded controller (power management controller) for managing power of the display device 100, and a keyboard controller for controlling a touch sensor controller for controlling the touch sensor 107 are integrated.

The touch sensor 107 is provided by overlaid, for example, on a display screen of the display 104 to detect a touch operation to the display 104 by a user. In addition, the touch operation is not only the operation of touching the display 104, but may include the operation of getting closer to the display 104 without touching.

A WLAN module 110 and the BT module 111 execute the communication with external equipment through an antenna (not shown).

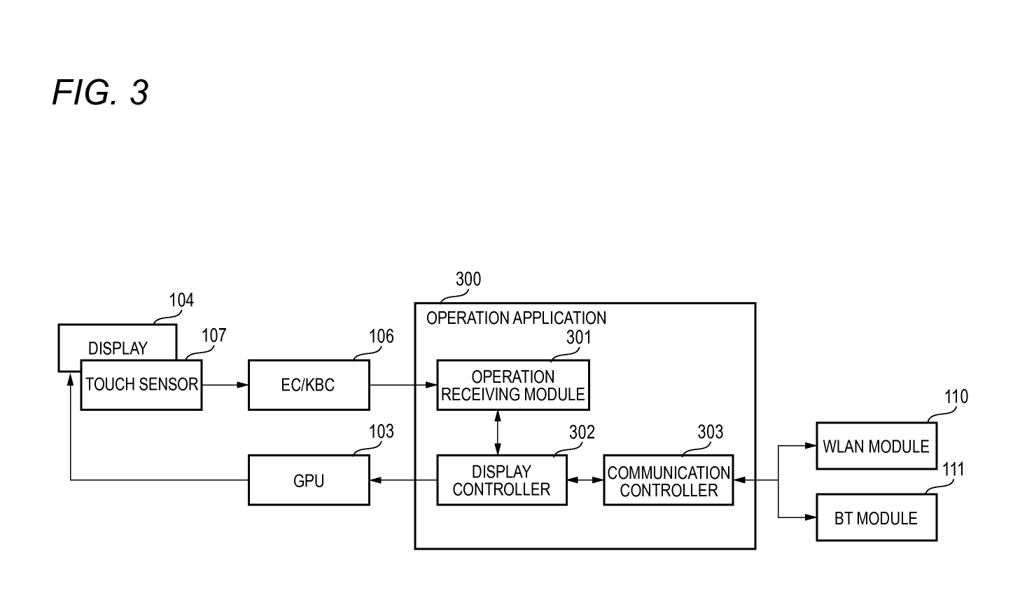

FIG. 3 shows a structural example of an SW/HW processing block in relation to the operation application 300 of the display device 100.

The operation application 300 is provided with an operation receiving module 301, a display controller 302 and a communication controller 303.

Operation information is input from the EC/KBC 106 to the operation receiving module 301. Here, the operation information refers to coordinate information and the like of the touch operation detected by the touch sensor 107, for example. Then, the operation receiving module 301 outputs the input operation information to the display controller 302.

The display controller 302 generates an operation screen including a variety of icons (buttons) for operating the air conditioning device. In addition, the display controller 302 of the present embodiment generates the operation screen in accordance with air temperature, season, etc. Then, the generated operation screen is output to the GPU 103 to be displayed on the display 104.

Furthermore, the display controller 302 determines to which of icons in the operation screen the operation has been done based on the operation information which is input from the operation receiving module 301. Then, the display controller 302 gives the communication controller 303 an instruction on generation and transmission of a command in accordance with the determined result concerned. Furthermore, status information of the first air conditioning device 201 and that of the second air conditioning device 202 are input from the communication controller 303 to the display controller 302.

The communication controller 303 executes generation, transmission and reception of a command in accordance with ECHONET Lite protocol. The kind of command to be generated and transmitted includes, for example, a request for start/stop of the air conditioning device, a request for status information, a request for changing a running mode, a request for changing a target temperature, etc. Moreover, the kind of command to be received includes status information and the like. In addition, although the status information contains information on the current running mode of the air conditioning device, outside air temperature, indoor air temperature, humidity and the like, the information on outside air temperature or humidity may not be contained depending on the model of the air conditioning device.

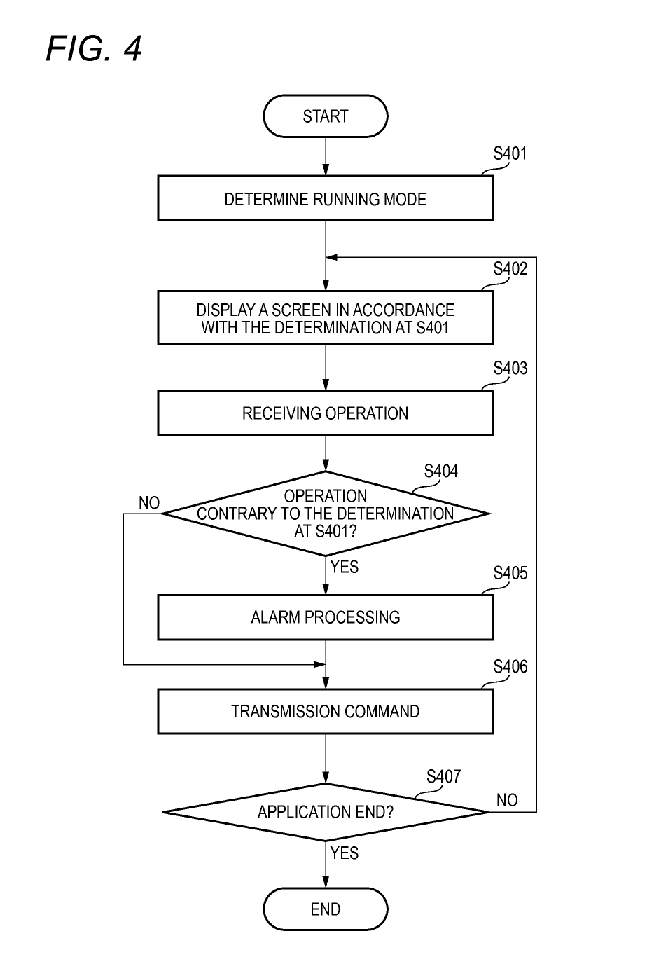

FIG. 4 shows a process flow by the operation application 300. First, the operation application determines an unnecessary running mode out of cooling, dehumidification and heating (S401). Here, when the air conditioning device has a function of measuring indoor air temperature and humidity and the outdoor unit of the air conditioning device concerned has a function of measuring outdoor air temperature, the operation application 300 extracts information on indoor air temperature, humidity and outdoor air temperature contained in the status information which is obtained from the air conditioning device concerned. In addition, the operation application 300 may obtain through an external network the information on outdoor air temperature and humidity in the area where the device itself stands. Then, the operation application determines that the heating is unnecessary if both the indoor air temperature and the outdoor air temperature are 25° C. or above, the cooling is unnecessary if both the indoor air temperature and the outdoor air temperature are 20° C. or below, and the cooling and dehumidification are unnecessary if the discomfort index is 70 or below, and the like, for example.

Otherwise, if the display device 100 cannot obtain the measurements such as temperature, humidity, etc., from the air conditioning device, the operation application 300 may obtain information on date calculated by a clock function of the display device 100, and determine, based on the date, the running mode out of cooling, dehumidification and heating which is less likely to be used. More specifically, the operation application 300 may determine that the cooling and dehumidification modes are less likely to be used from November to March in Japan, and determine that the heating mode is less likely to be used from June to September in Japan.

Next, the display controller 302 generates an operation screen with a display form (layout) in accordance with the determination at S401 (S402). Here, when an icon on the operation screen is operated (S403) and the operation concerned is one which is regarded as being inappropriate in such a display form (YES at S404), the display controller 302 generates an alarm image to be displayed on the display 104 (S405). Then, the operation application 300 executes the processing such as issue of a command and the like in accordance with the operation to the alarm image (S406). Furthermore, the processing such as issue of a command and the like is executed also in the case where the processing proceeds to NO at S403 (S406). Then, the processing from S401 to S406 ends when the program ends (Yes in S407).

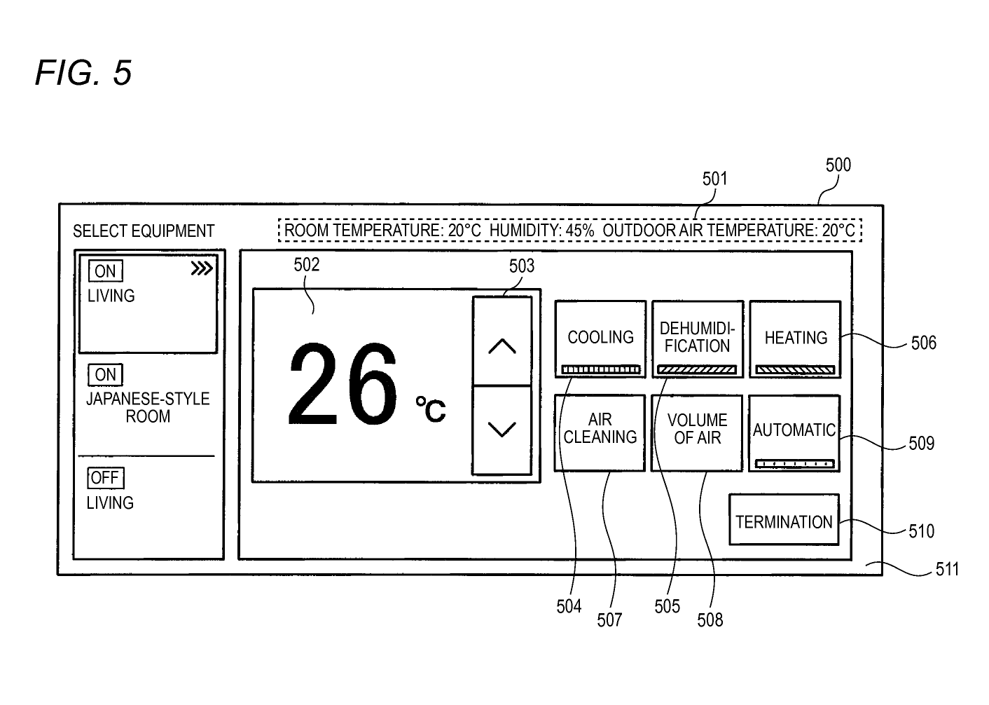

FIG. 5 shows an example of screen configuration of an operation screen. The operation screen 500 is provided with an environment data 501, a setting temperature 502, a temperature adjusting icon 503, mode switching icons 504 to 509, a termination icon 510, a background image 511, etc. In addition, the operation screen 500 is displayed when the outdoor air temperature is 20 to 22° C., for example. Otherwise, the operation screen 500 is displayed from April to May and from October to November in Japan. More specifically, the operation screen 500 is displayed in the season or at the temperature in which it is unclear which of the cooling function or the heating function is to be utilized.

The environment data 501 shows room temperature, humidity and outdoor air temperature. Here, the display controller 302 obtains status information containing room temperature, humidity and outdoor air temperature from the air conditioning device which is to be operated by the operation screen 500. Then, the display controller 302 generates and displays the environment data 501 based on the status information concerned.

The setting temperature 502 is a target temperature set for the air conditioning device to be operated, and the temperature adjusting icon 503 is an icon which receives the operation for changing the target temperature. The mode switching icon 504 is an icon which receives the operation for changing the air conditioning device into the cooling mode. The mode switching icon 505 is an icon which receives the operation for changing the air conditioning device into the dehumidification mode. The mode switching icon 506 is an icon which receives the operation for changing the air conditioning device into the heating mode. The mode switching icon 507 is an icon which receives the operation for changing the air conditioning device into the air cleaning mode. The mode switching icon 508 is an icon which receives the operation for changing the volume of air of the air conditioning device. The mode switching icon 509 is an icon which receives the operation for changing the air conditioning device into the automatic running mode. Then, when receiving the operations to these icons, the communication controller 303 transmits a command to given the air conditioning device to be operated an instruction on the operation in a mode in accordance with the icon. The termination icon 510 is an icon which receives the operation for terminating the air conditioning device. The background image 511 is a wallpaper adapted to season, for example.

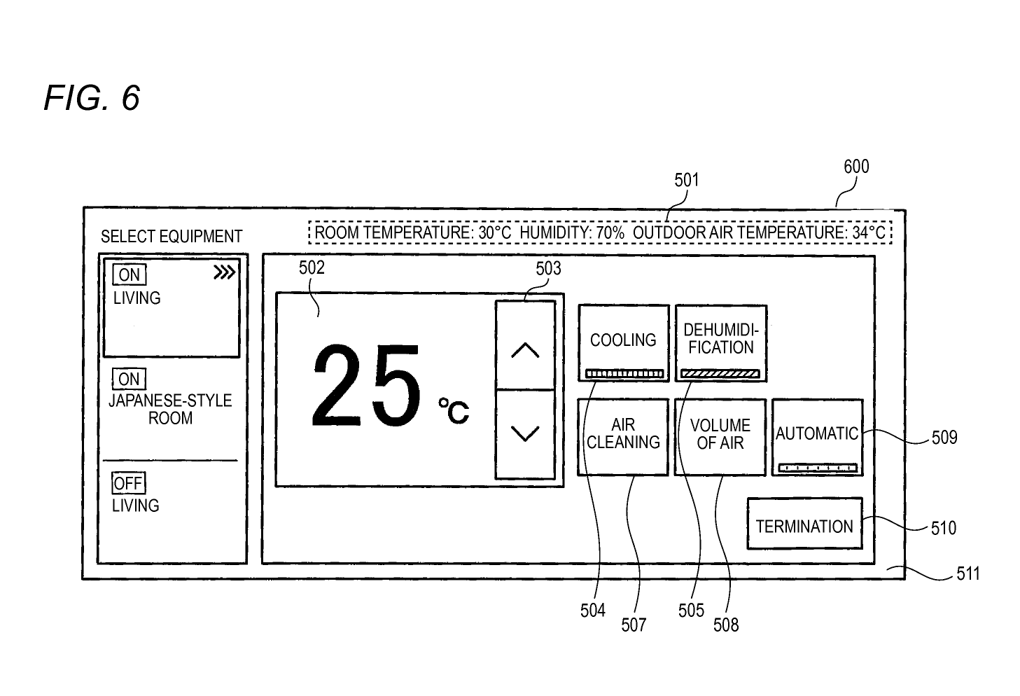

FIG. 6 is an example of layout of the operation screen displayed in the season or at the temperature in which the use of heating is commonly considered to be inappropriate. More specifically, an operation screen 600 is displayed in the case where the outdoor air temperature is 25° C. or above, both the indoor air temperature and the outdoor air temperature are 25° C. or above, or the date is in June to September, for example. In addition, in the operation screen 600, like reference is assigned to the structure having like function in the operation screen 500. Here, the operation screen 600 hides the mode switching icon 506 which has been displayed on the operation screen 500, i.e., the icon for receiving the instruction on heating mode. Then, the background image 511 is cold color such as blue-type colors and the like.

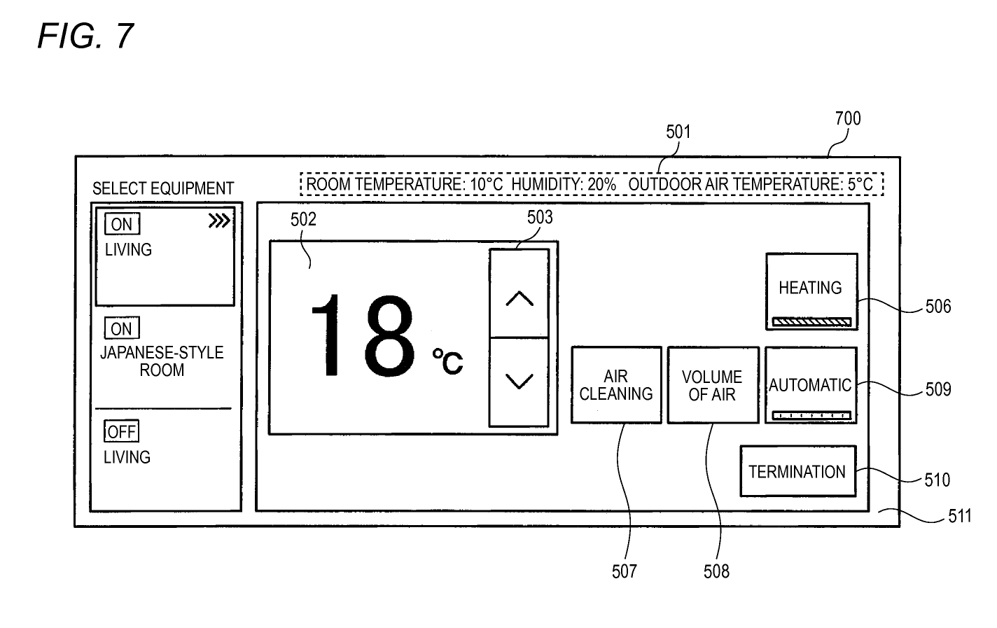

On the other hand, FIG. 7 is an example of layout of the operation screen displayed in the season or at the temperature in which the use of cooling is commonly considered to be inappropriate. More specifically, an operation screen 700 is displayed in the case where both the indoor air temperature and the outdoor air temperature are 20° C. or below, the outdoor air temperature is 20° C. or below, or the date is in November to March, for example. In addition, in the operation screen 700, like reference is assigned to the structure having like function in the operation screen 500. Here, the operation screen 700 hides the mode switching icons 504 and 505 which has been displayed on the operation screen 500, i.e., the icons for receiving the instruction on cooling mode. Then, the background image 511 is warm color such as red-type colors and the like. In addition, in FIG. 7, although two icons 504 and 505 are hidden because both the cooling mode and the dehumidification mode are modes in relation to cooling, one of the icon 504 of the cooling mode and the icon 505 of the dehumidification mode may be hidden depending on the condition of air temperature and humidity.

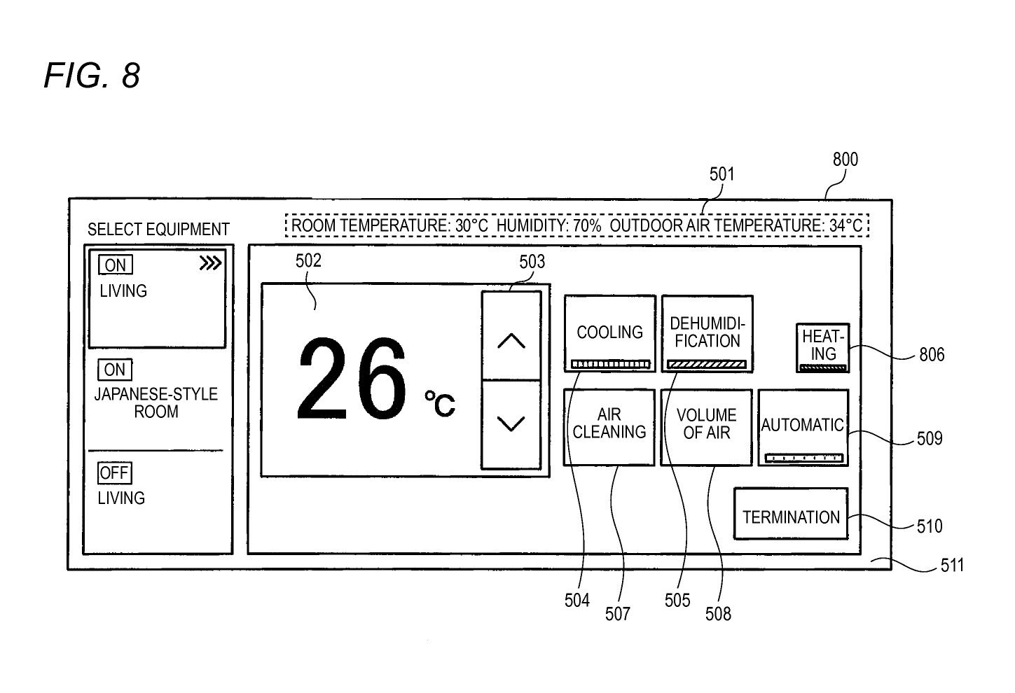

FIG. 8 is an example of other layout of the operation screen displayed in the case where the use of heating is inappropriate. An icon 806 which is the reduced icon 506 on the operation screen 500 is displayed on an operation screen 800. When the display controller 302 determines the display form of the operation screen to be displayed based only on date, heating may be required even in summer due to the cold weather. The operation screen 800, however, makes it possible to utilize the heating even in such a case. Therefore, the display device 100 may display the operation screen in FIG. 6 or 7 when obtaining information, for example, on air temperature to be able to determine the necessity of icon of each running mode, whereas display the operation screen in FIG. 8 when failing to obtain information on air temperature so as to determine the necessity of icon of each mode based on information on date.

Here, the icon 806 is smaller in size than the icons 504 and 505 in relation to cooling. Furthermore, the interval between the icon 806 and the icon 505 is larger than the interval between the icon 804 and the icon 805. In addition, although the operation screen 800 displays the icon 806 in the same line as the icons 504 and 505 in relation to cooling, the icon 806 may be displayed in the other line.

Furthermore, if the use of cooling is inappropriate, the display controller 302 may reduce the icons 504 and 505 in relation to cooling, or change the display positions thereof, similar to the operation screen 800.

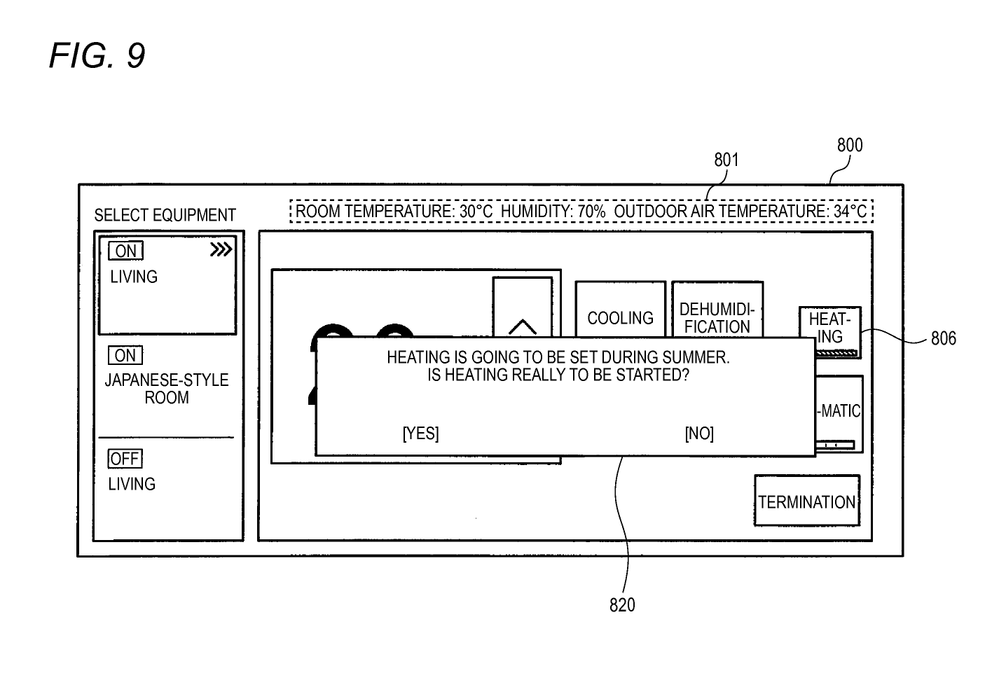

FIG. 9 is an alarm image which is displayed on the operation screen 800 when the icon 806 receives the operation input. Here, since the operation input for heating is received in season and temperature in which the use of heating is considered to be inappropriate, a message is displayed which confirms whether or not the control by the operation input concerned is to be really executed. Then, when the operation regarding “YES” is received, a request for starting heating is transmitted to the air conditioning device. When receiving the operation regarding “NO”, the display device 100 does not transmit a request to the air conditioning device, and returns to the display of the operation screen 800 in FIG. 8.

While several embodiments of the present invention have been described, these embodiments are adduced as examples and the limitation of the scope of the invention is not intended. Those novel embodiments can be implemented in other various forms, and various omissions, replacements and modifications can be made without departing the gist of the invention. Those embodiments and the variations thereof are included in the scope of the invention and the summary thereof, as well as included in the scope of the invention described in Claims and that of equivalents thereof.

What is claimed is:

1. A display device, comprising:
a CPU (central processing unit);
a display controller configured to display a first icon and a second icon in predetermined layouts on a display, the first icon receiving an instruction for executing a mode in relation to cooling and the second icon receiving an instruction for executing a mode in relation to heating; and
an obtain module configured to obtain information on at least one of air temperature and date,
wherein the display controller changes a layout of one icon of the first and second icons and maintains a layout of the other icon of the first and second icons based on the information when the information meets a predetermined condition.

2. The display device of claim 1,
wherein the display controller hides the one icon by changing the layout of the one icon when the information meets a predetermined condition.

3. The display device of claim 1,
wherein, when the information meets a predetermined condition, the display controller changes a size of the one icon to be smaller than a predetermined size of the one icon in a case where the one icon is displayed in the predetermined layout.

4. The display device of claim 1,
wherein the display controller changes a display position of the one icon when the information meets a predetermined condition.

5. The display device of claim 1,
wherein the obtain module obtains the information in relation to air temperature from an air conditioning device, and
the display controller changes the layout of the one icon when the air temperature obtained by the obtain module meets a predetermined condition.

6. The display device of claim 5,
wherein the obtain module obtains information in relation to indoor air temperature, outdoor air temperature and humidity from the air conditioning device, and
the display controller changes the layout of the one icon when the indoor air temperature, the outdoor air temperature or the humidity meets a predetermined condition.

7. The display device according to claim 5,
wherein, in a case where the obtain module cannot obtain the information on air temperature from the air conditioning device, the display controller changes the layout of the one icon when the information on date meets a predetermined condition.

8. The display device according to claim 5,
wherein the display controller hides the one icon when the obtain module obtains the information on air temperature from the air conditioning device, and
the display controller changes the layout of the one icon while keeping the other icon displayed, based on the information on date when the obtain module cannot obtain the information on air temperature from the air conditioning device.

9. A display method in a display device including a CPU (central processing unit) and a display, comprising:
displaying a first icon and a second icon in predetermined layouts on the display, the first icon receiving an instruction for executing a mode in relation to cooling and the second icon receiving an instruction for executing a mode in relation to heating;
obtaining information on at least one of air temperature and date; and
changing a layout of one icon of the first and second icons and maintaining a layout of the other icon of the first and second icons based on the information when the information meets a predetermined condition.

10. A display system provided with an air conditioning device and a display device, the display device comprising:
a display controller configured to display a first icon and a second icon in predetermined layouts on a display, the first icon receiving an instruction for executing a mode in relation to cooling and the second icon receiving an instruction for executing a mode in relation to heating; and
an obtain module configured to obtain information on at least one of air temperature and date,
wherein the display controller changes a layout of one icon of the first and second icons and maintains a layout of the other icon of the first and second icons based on the information when the information meets a predetermined condition.
